(19) United States
(12) Patent Application Publication
(10) Pub. No.: US 2014/0216669 A1
(43) Pub. Date: Aug. 7, 2014

(54) REMOTE ENGAGEMENT AND ACTUATION APPARATUS AND RELATED METHODS

(71) Applicant: David S. George, Brea, CA (US)

(72) Inventor: David S. George, Brea, CA (US)

(21) Appl. No.: 13/801,875

(22) Filed: Mar. 13, 2013

Related U.S. Application Data
(60) Provisional application No. 61/610,125, filed on Mar. 13, 2012.

(51) Int. Cl. B66F 19/00

(52) U.S. Cl. CPC B66F 19/00
USPC 160/405; 294/175

(57) ABSTRACT

A tool for reaching, engaging, and/or actuating things such as awnings on the side of recreational vehicles includes a handle, an engagement element remote from the handle, and a connection structure between the handle and the engagement element, various elements of the tool of sufficient size and strength and configuration to permit a user to selectively push or pull the awning or other things.

### CROSS-REFERENCE TO RELATED APPLICATIONS

This application claims priority to U.S. Provisional Application Ser. No. 61/610,125, filed Mar. 13, 2012, the disclosure of which is incorporated herein by reference in its entirety.

### FIELD OF INVENTION

The present invention is described herein with reference to the accompanying Figures, which serve as illustrations of some of the many embodiments in which the invention may be practiced. Generally in those Figures and references, similar reference numerals refer to similar or identical elements throughout this description. However, such similar reference numerals are subject to the context and other factors, including for example the understanding of persons of ordinary skill in the arts relevant to the inventions.

Those Figures and references, and the other terminology used in these descriptions, are not intended to be interpreted in any limited or restrictive manner, simply because it is being utilized in conjunction with a detailed description of certain embodiments of the invention. Furthermore, various embodiments of the invention (whether or not specifically described herein) may include one or more novel features, no single one of which (a) is necessarily solely responsible for one or more desirable attributes of the invention or (b) is essential to practicing the inventions described.

### BRIEF DESCRIPTION OF DRAWINGS

FIG. 1 is a perspective view of a preferred embodiment of the tool of the present invention.

FIG. 1A is a side view of the tool of FIG. 1.

FIG. 1B is a top view of the tool of FIG. 1.

FIG. 1C is a side view of the other side of the tool of FIG. 1 (viewed from the opposite side as shown in FIG. 1A).

FIG. 1D is a top view similar to FIG. 1B, but illustrates the tool of FIG. 1 as it may appear when collapsed to a shorter length.

FIG. 1E is a side view similar to FIG. 1C, but illustrates the tool of FIG. 1 as it may appear when collapsed to a shorter length.

FIG. 2D is similar to FIG. 1A, but illustrates a wire-frame view of the tool of FIG. 1.

FIG. 2C is similar to FIG. 1B, but illustrates a wire-frame view of the tool of FIG. 1.

FIG. 2B is similar to FIG. 1C, but illustrates a wire-frame view of the tool of FIG. 1.

FIG. 2A is similar to FIG. 2C, but illustrates a wire-frame view of the tool of FIG. 1 from the bottom (the opposite side from FIG. 2C).

FIG. 2E also is a wire-frame view, showing an end view of the device shown in FIG. 2B.

FIG. 2F also is a wire-frame view, showing the opposite end view of the device shown in FIG. 2B.

FIG. 3A is an enlarged view of the right-most end of the tool of FIG. 1C and 2B. FIG. 3B is an enlarged view of the right-most end of the tool of FIG. 2C and 1B. FIG. 3C is an enlarged view of the right-most end of the tool of FIG. 1A and 2D. FIG. 3D is an exploded perspective view of the apparatus shown in FIG. 3C.

FIG. 3E is an even more enlarged view of the apparatus shown in FIG. 3A.

FIG. 3F is an even more enlarged view of the apparatus shown in FIG. 3B.

FIG. 3G is an even more enlarged view of the apparatus shown in FIG. 3C.

FIG. 3H is an even more enlarged view of the apparatus shown in FIG. 3D.

FIG. 3I is similar to FIG. 3H, but shows the apparatus in wireframe.

FIG. 4A is an enlarged view of the left-most end of the embodiment of FIG. 2D.

FIG. 4B is an enlarged view of the left-most end of the embodiment of FIG. 2C.

FIG. 4C is an enlarged view of the left-most end of the embodiment of FIG. 2B.

FIG. 4D is an enlarged view of the left-most end of the embodiment of FIG. 2A.

FIG. 5A is an enlarged view of the first sliding joint on the left end of the embodiment of FIG. 2D.

FIG. 5B is an enlarged view of the first sliding joint on the left end of the embodiment of FIG. 2C.

FIG. 6A is an enlarged view of the generally central joint on the left end of the embodiment of FIG. 2D.

FIG. 6B is an enlarged view of the generally central joint on the left end of the embodiment of FIG. 2C.

FIG. 7A is an enlarged view of the right-most sliding joint of the embodiment of FIG. 2C.

FIG. 7B is an enlarged view of the right-most sliding joint of the embodiment of FIG. 2D.

FIG. 7C is an enlarged view of the right-most sliding joint of the embodiment of FIG. 2B.

FIG. 7D is an enlarged view of the right-most sliding joint of the embodiment of FIG. 2A.

FIG. 8A is an enlarged view of the right-most end of the embodiment of FIG. 2B.

FIG. 8B is an enlarged view of the right-most end of the embodiment of FIG. 2C.

FIG. 9A is a perspective view similar to FIG. 2D, but shows the apparatus rotated at approximately 90 degrees from that shown in FIG. 2D.

FIG. 9B is a similar to FIG. 9A, but shows the apparatus rotated at approximately 90 degrees from that shown in FIG. 9A.

FIG. 10A is an enlarged perspective view of the right-most sliding joint of FIGS. 7A-D, but not in wire-frame, and illustrating certain details of a preferred embodiment.

FIG. 10B is similar to FIG. 10A, but illustrates the joint from a different perspective view.

FIG. 10C is similar to FIG. 10A, but shows an even more enlarged and foreshortened view of same.

FIG. 11 is a perspective view of one of the many RV (travel trailer) machines with which the tool of FIG. 1 may find utility. Among other things, it illustrates an awning and steps in their retracted positions.

FIG. 12 illustrates another of the many travel trailers with which the tool of FIG. 1 may be used, with the awning in an extended position.

FIG. 13 is a partially exploded view of one of the many awnings assemblies with which the tool of FIG. 1 may be used, with the awning in an extended position and a representative rafter assembly shown in the right half of the Figure, and an end view of a ratchet lever shown in the bottom left quadrant of the Figure.

FIG. 14A is a photograph of an awning similar to that illustrated in FIG. 13, including a ratchet lever and an embodiment of the tool of FIG. 1 positioned to engage that ratchet lever.

FIG. 14B is a photograph of another awning similar to that illustrated in FIG. 13, showing the tool of FIG. 1 as it may be used to engage the ratchet apparatus of FIG. 13 to extend the awning.

FIG. 14C is similar to FIG. 14B, but shows a close-up view of the end of the tool as it engages the ratchet.

FIG. 14D is a photograph illustrating the tool engaged with a strap attached to an awning on the side of an RV, as it can be used to pull the awning into an extended position.

FIG. 14E is similar to FIG. 14D, but shows the awning in a more extended position.

FIG. 14F is similar to FIG. 14E, but shows the awning from a different perspective.

FIG. 15A is a photograph that illustrates the tool of FIG. 1 as it may be used with another awning assembly, one that is shorter and smaller than that illustrated in FIGS. 14D-F.

FIG. 15 B is a close-up view of the apparatus shown in FIG. 15A, showing the engagement of the tool with the strap.

FIGS. 16A-B illustrate the tool of FIG. 1 as it may be used in one of many other applications, both in connection with travel trailer RVs and more generally, showing how it can be used to pull out or extend the steps under the RV's door. As with many of the other applications in which the invention may be used, the tool preferably also can be used to “push” the thing (steps, awning, other) back into a retracted position or otherwise away from the person using the tool. FIG. 16A is a photograph of the tool engaged with steps that are in a generally closed or retracted position. FIG. 16B is a photograph of the tool engaged with steps that are in a generally open or extended position.

FIGS. 17A-B are photographs that illustrate yet another of the many applications of the tool of FIG. 1, as it may be used in connection with a jack apparatus (such as might be used to hold up a portion of the RV/trailer). FIG. 17C is a photograph that shows the tool in use with a wheel block (such as might be used to keep the trailer from rolling).

FIG. 18 is a photograph that shows still another use for the tool of the embodiment of FIG. 1, in connection with reaching and actuating a drain apparatus on the RV.

FIGS. 19A-E illustrate other preferred embodiments of the present invention, wherein the tool is collapsible/expandable and/or telescoping. FIG. 19A is a side view of a partially opened tool, with arrows indicating movement by which the tool can be further opened or closed. FIG. 19B is similar to FIG. 19A, but illustrates a “scissor” embodiment of the tool of the invention, in a partially-extended position. FIG. 19C is a side view of an embodiment similar to that of FIG. 1, but shows how the invention may include other numbers of collapsible sections (in 19C an additional section is added beyond that of FIG. 1). FIG. 19D is a cross-sectional view illustrating how generally tubular embodiments of the section elements may be seated in relationship to each other (these are round while other embodiments may be square, rectangular, or other shapes), while FIG. 19E is a similar showing for channel-shaped section elements that can be held together in operative relationship by any suitable manner, including for example slightly inward tapering of the sides of the channel.

FIG. 20A is a perspective photograph of a preferred embodiment of the light assembly of the present invention, illustrating one of the many items that can be illuminated by the light.

FIG. 20B is a perspective photograph of a preferred embodiment of the light assembly of the present invention, illustrating another of the many items that can be illuminated by the light.

FIG. 20C is a perspective photograph of a preferred embodiment of the light assembly of the present invention, illustrating still another of the many items that can be illuminated by the light.

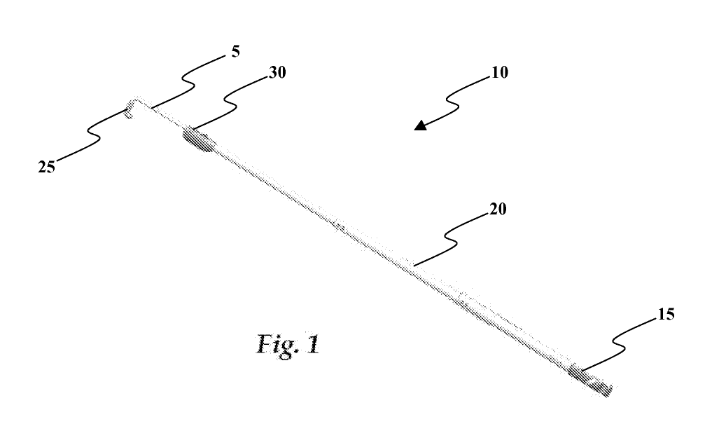

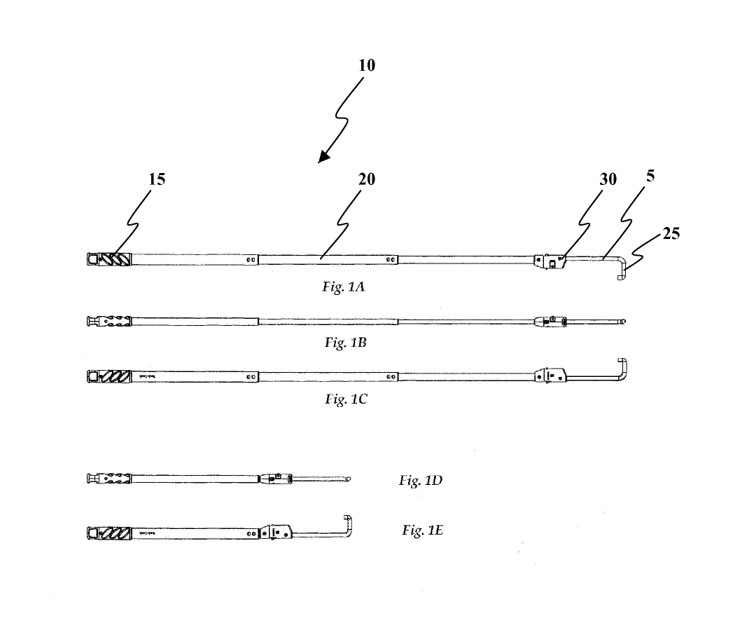

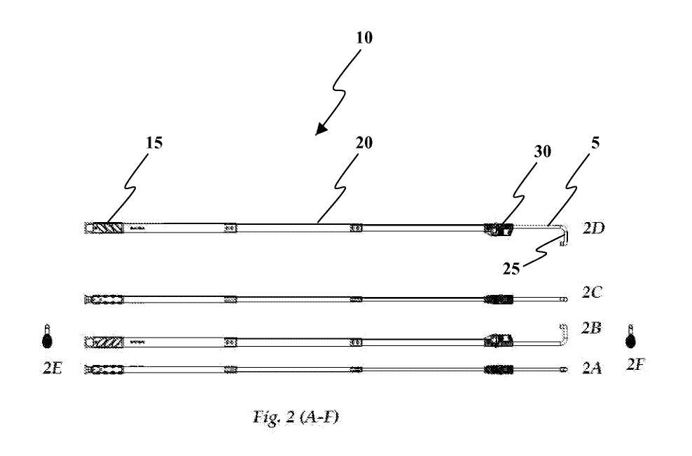

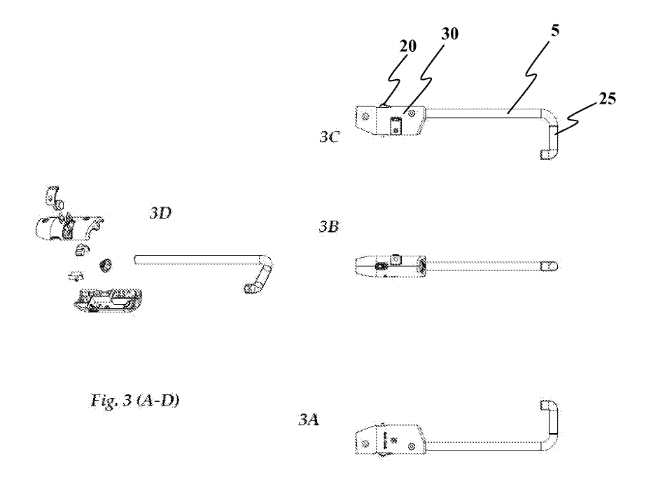

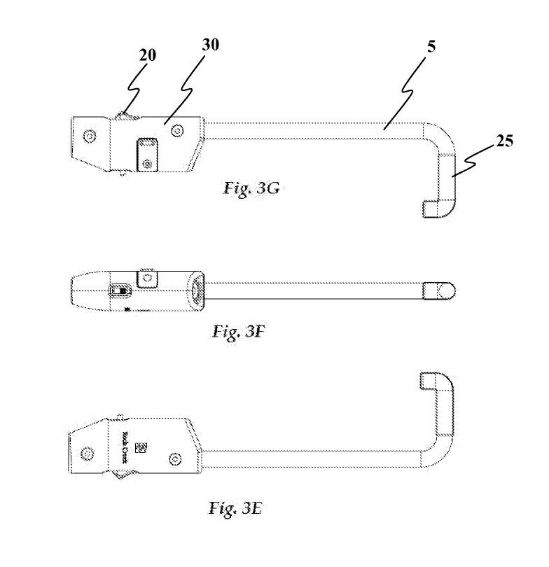

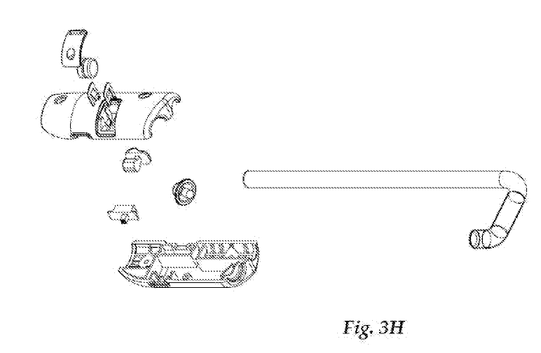

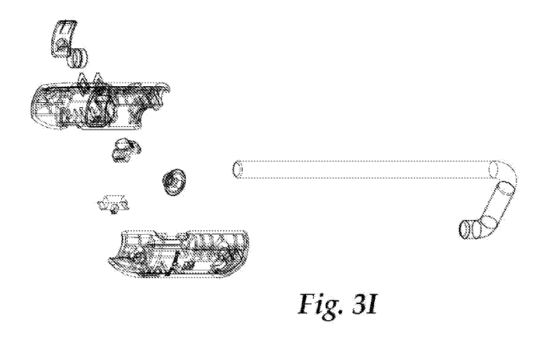

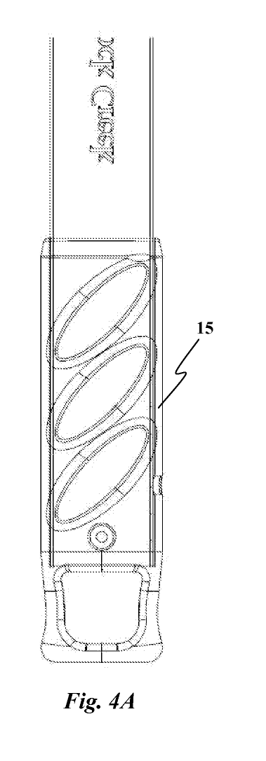

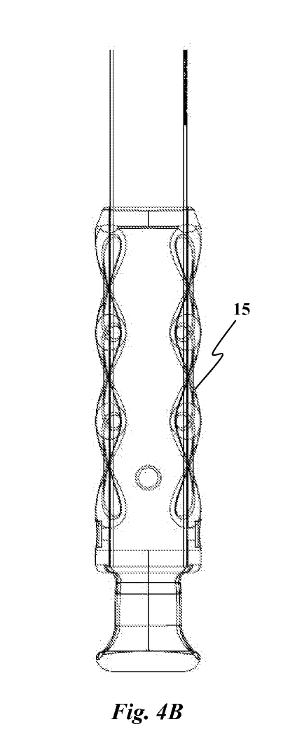

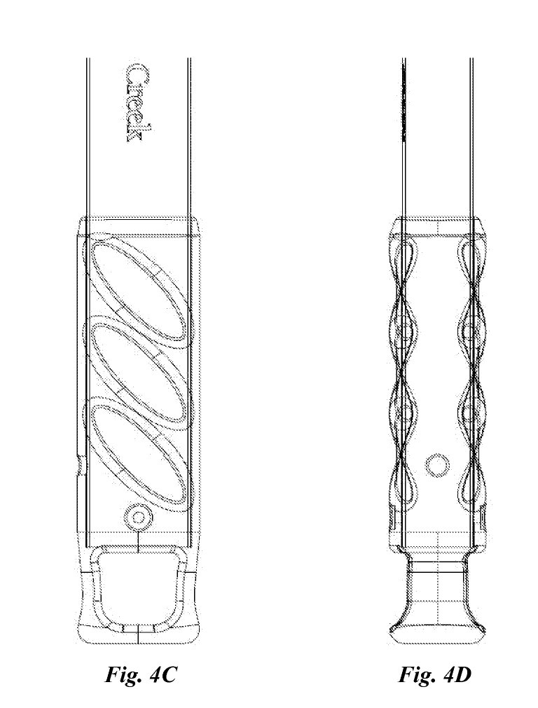

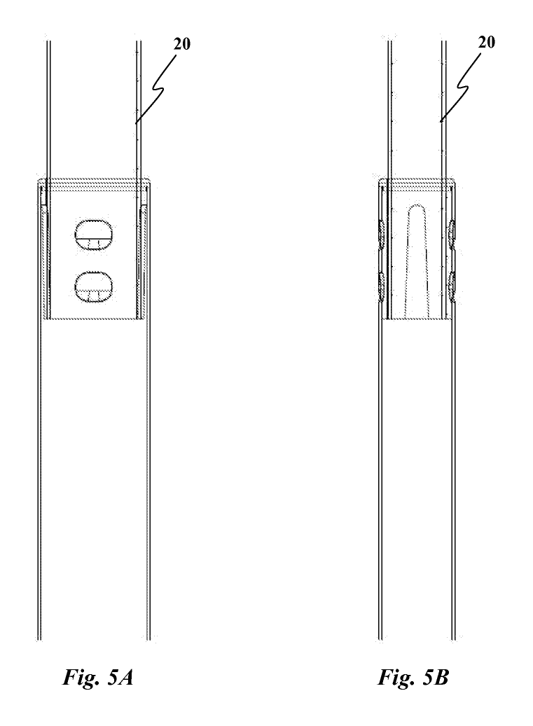

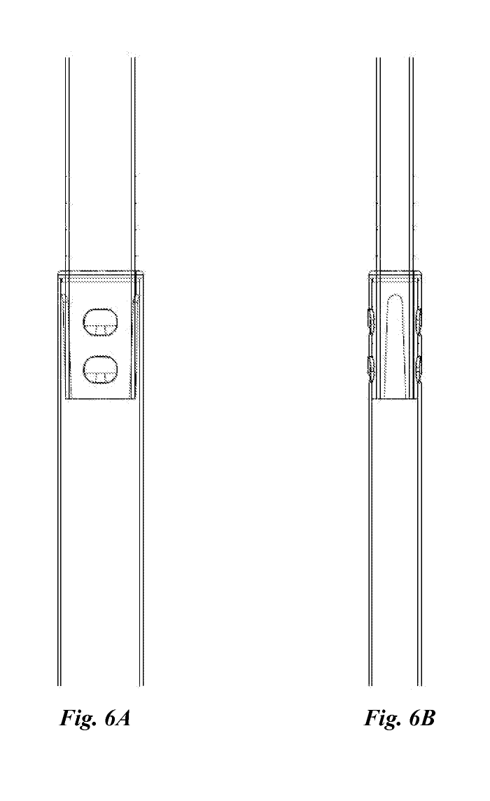

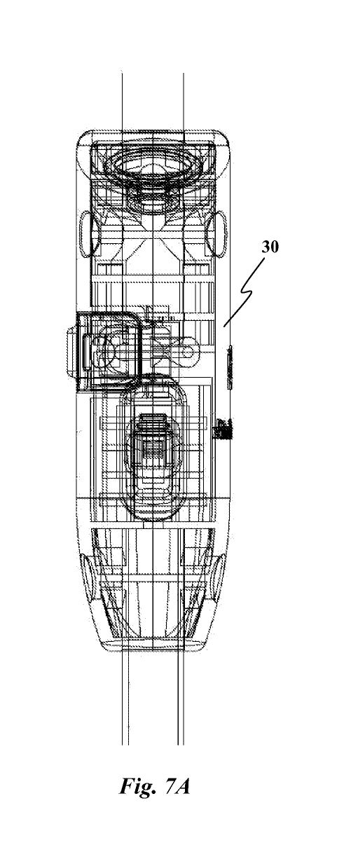

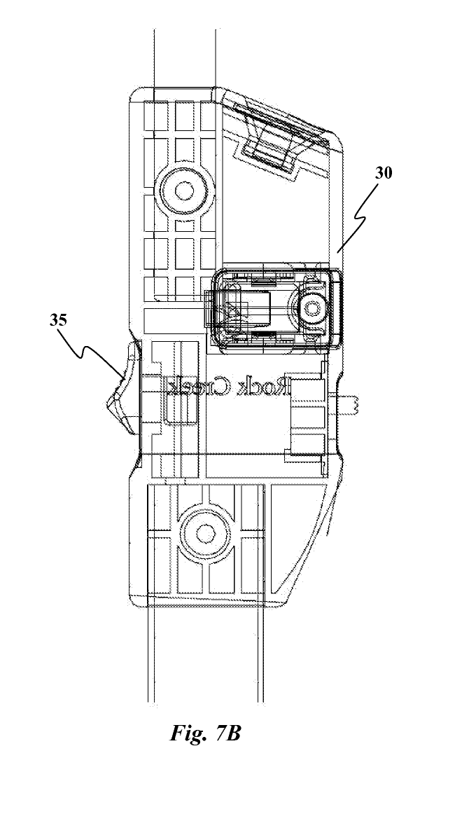

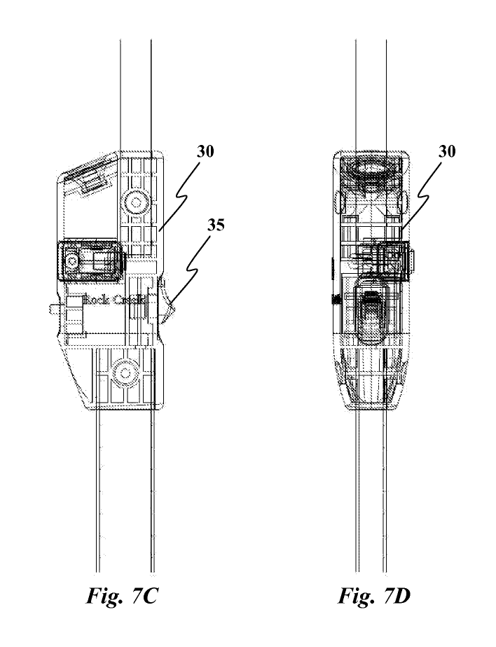

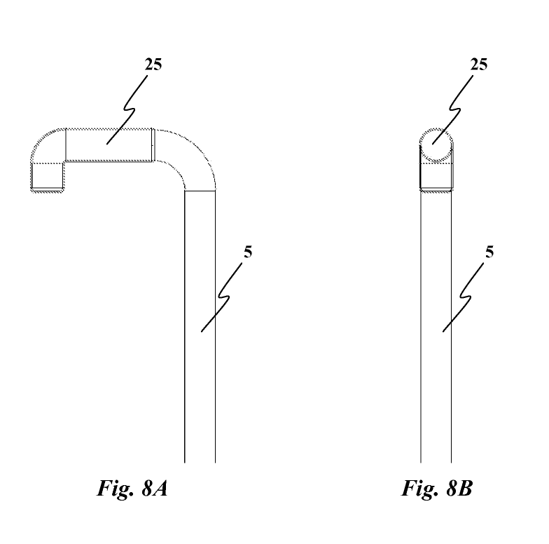

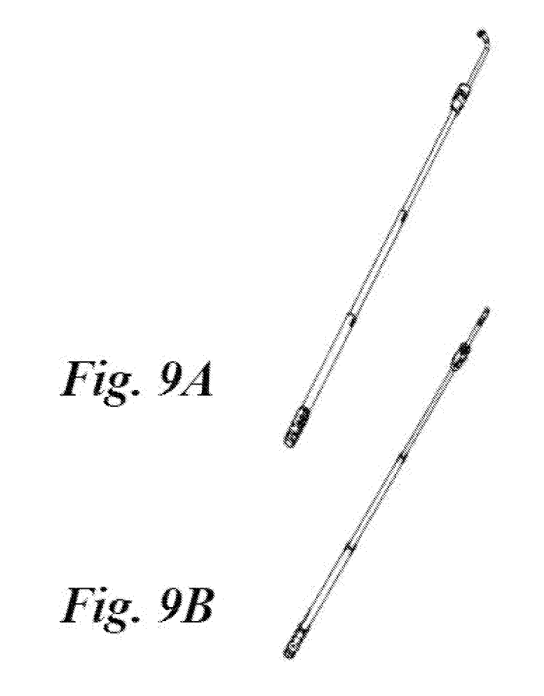

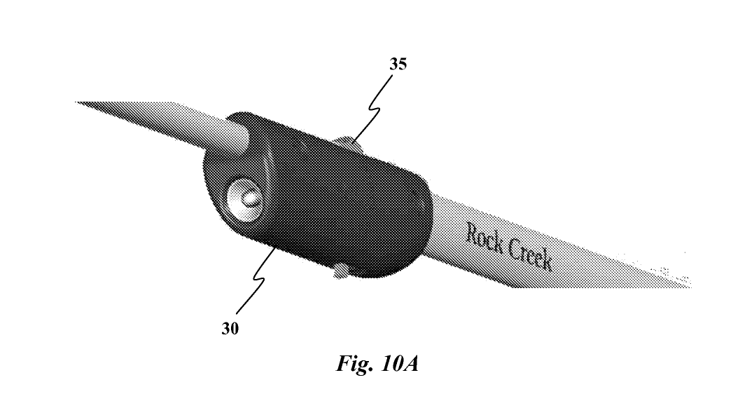

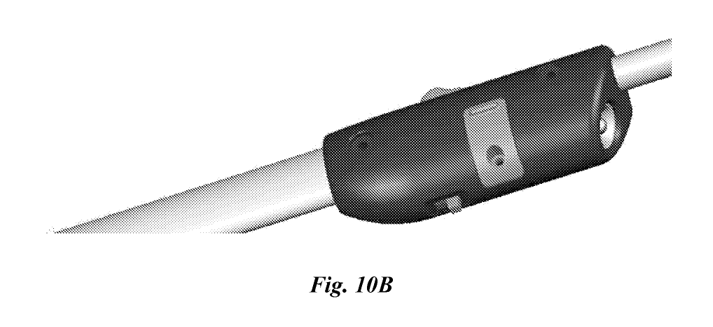

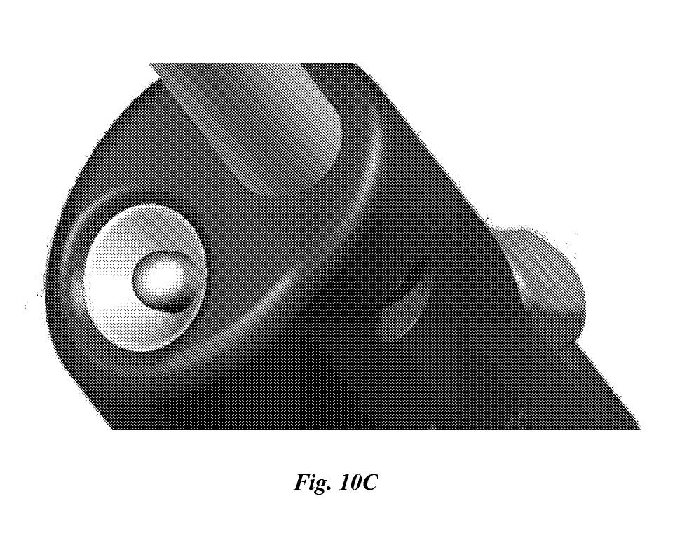

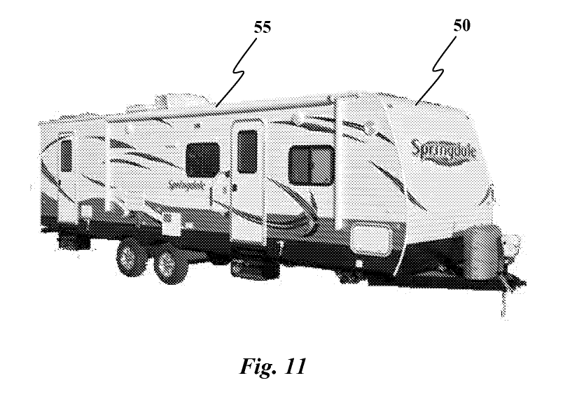

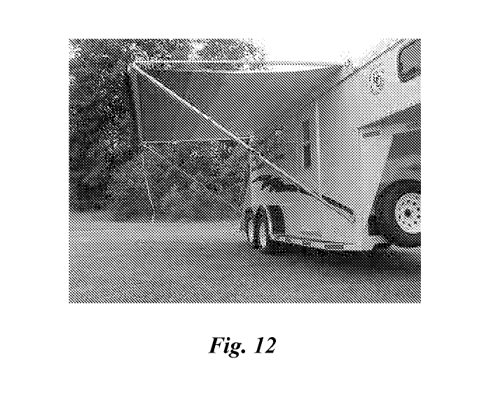

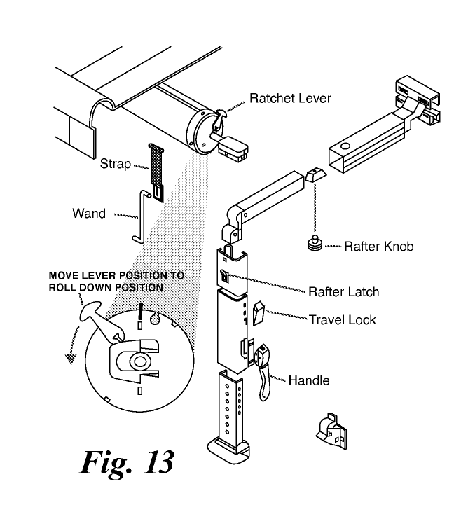

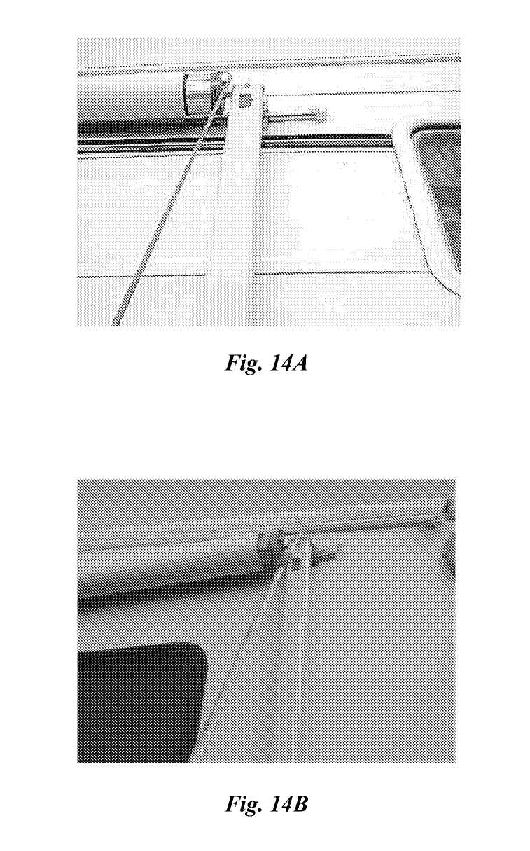

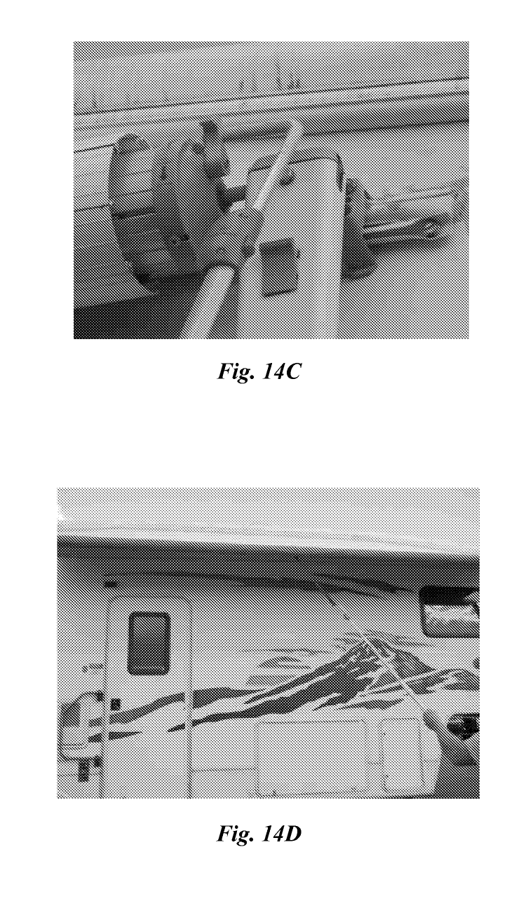

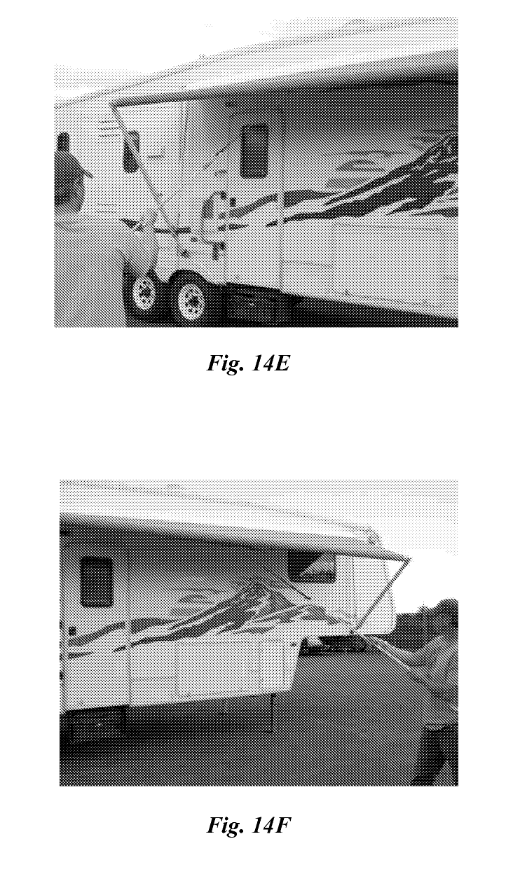

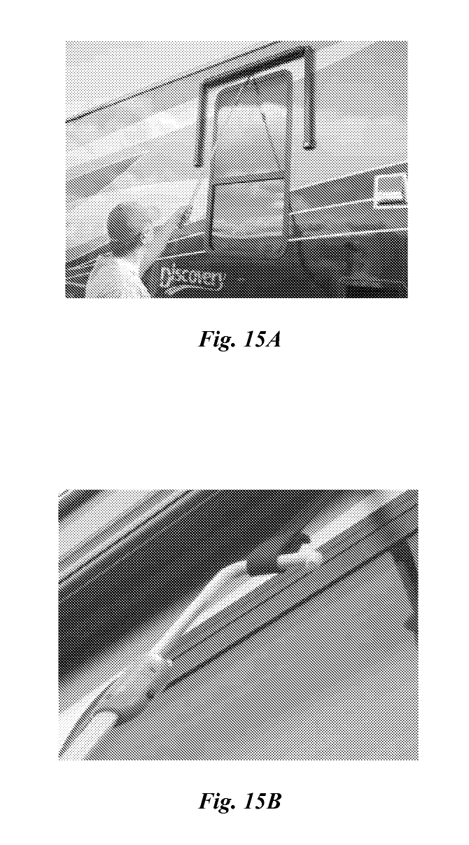

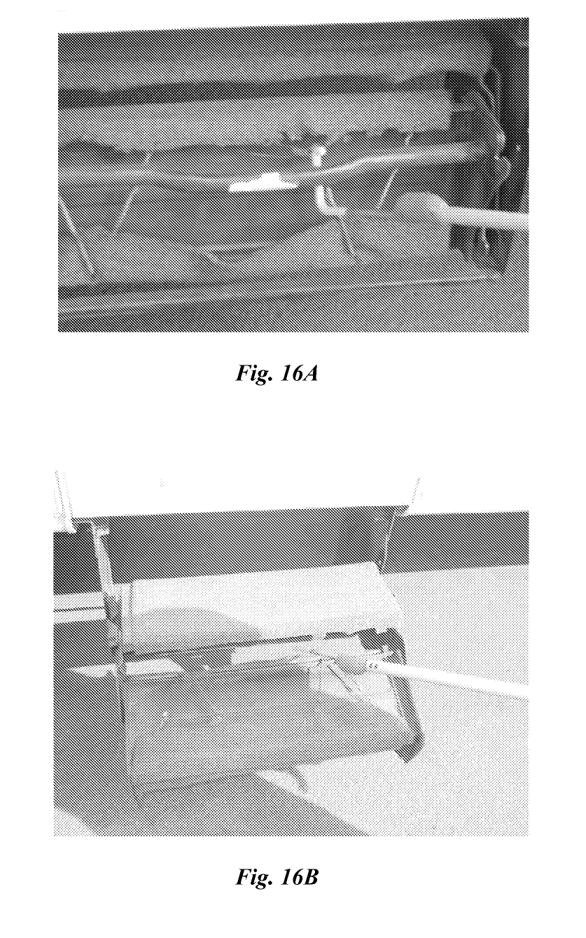

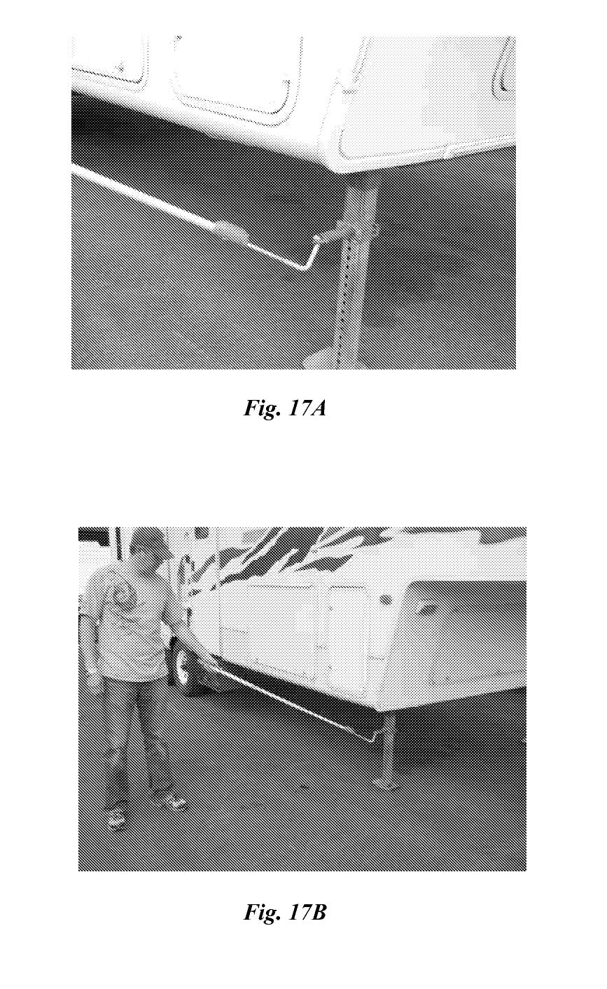

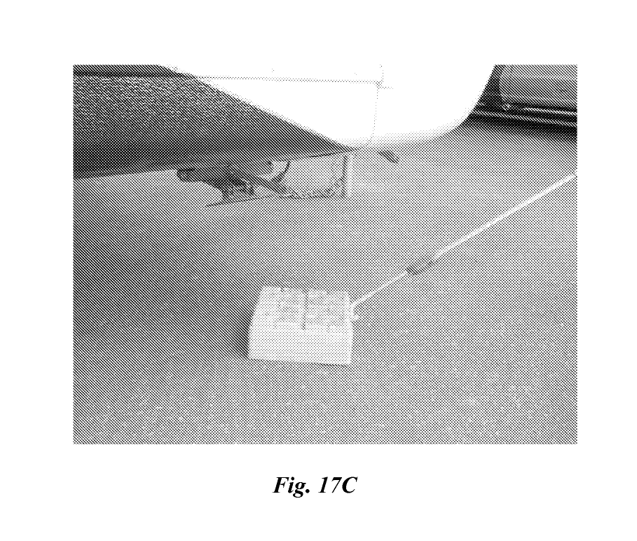

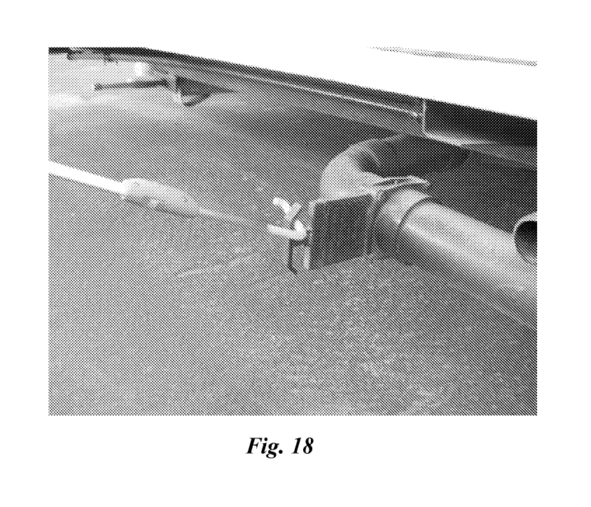

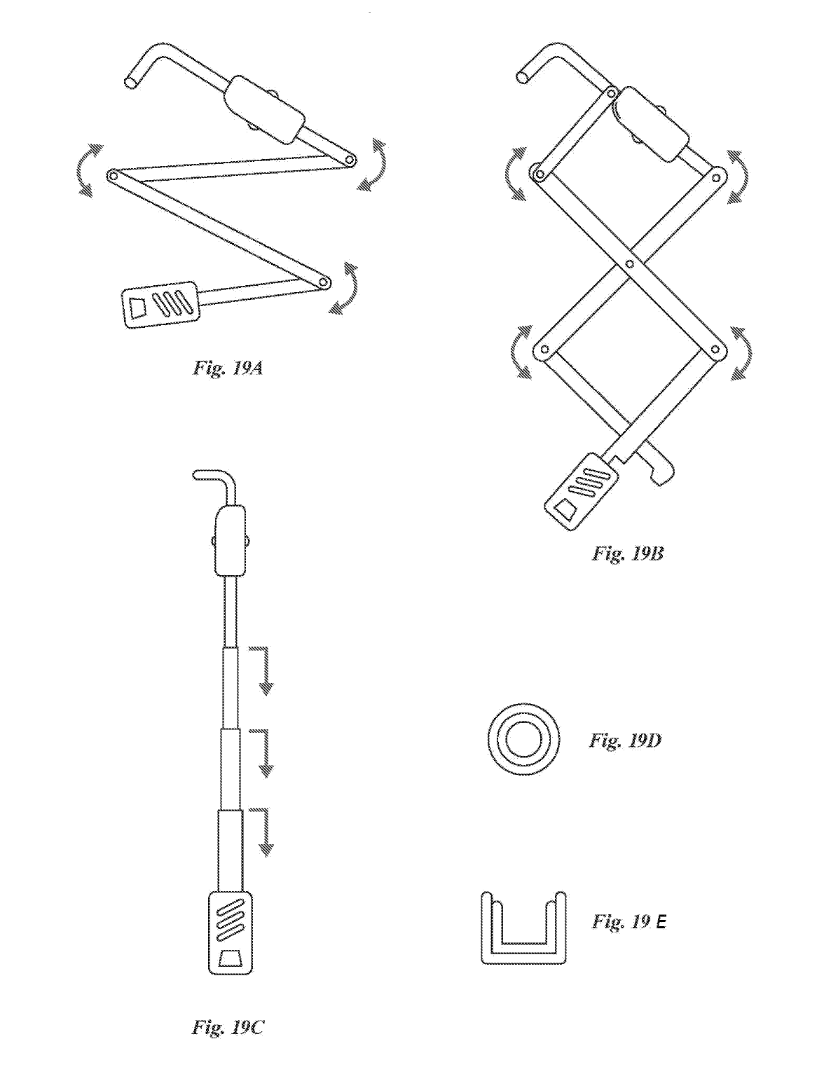

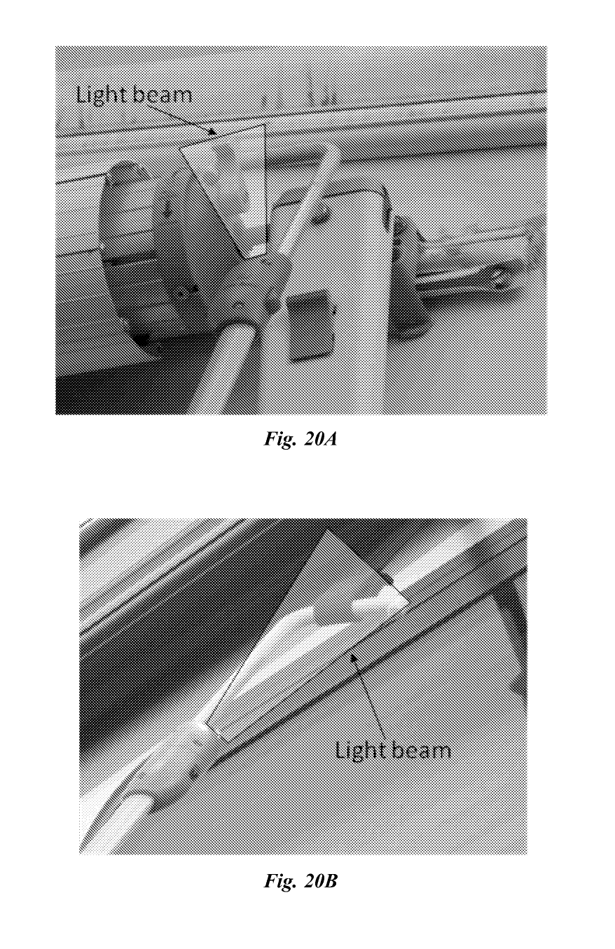

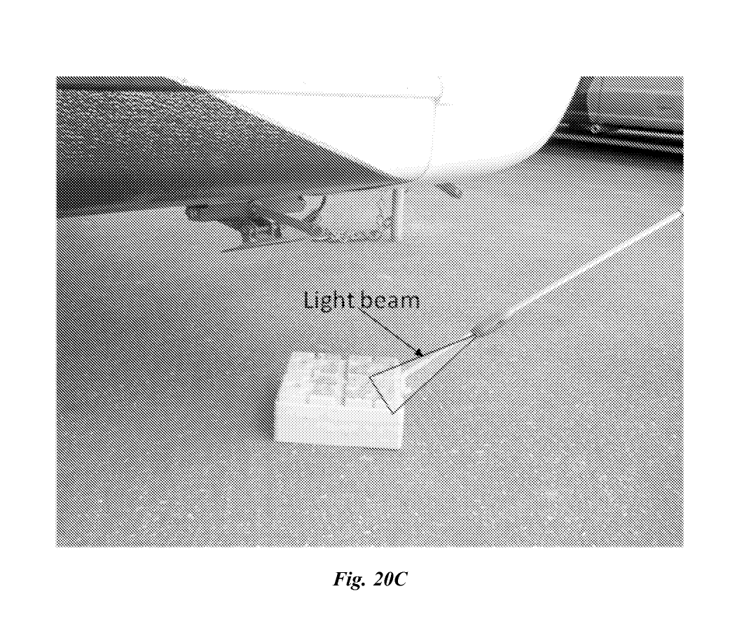

### DETAILED DESCRIPTION OF EMBODIMENTS

The present inventions preferably include and/or constitute a tool and related methods for reaching, engaging, moving, positioning, and/or actuating certain things such as awnings, jacks, steps, drains, and the like on RVs or similar vehicles. Although illustrated and discussed herein as used in connection with such a vehicle or similar application, the inventions have a broad range of other uses to assist persons in reaching, engaging, moving, positioning, and/or actuating other things.

Persons of ordinary skill in the art will understand that the tool may be fabricated from any suitable material and by any suitable method. Metal or plastic are preferred, and preferably some form of rust-prevention or other surface protection is included, at least for surfaces that otherwise may be damaged by use, weather, moisture, or the like. Preferably the tool is relatively lightweight but sufficiently strong and sturdy to accomplish its intended tasks. Also, although it is illustrated in a collapsible embodiment having a light and other features, persons of ordinary skill in the art will understand that many other embodiments (including ones that are not collapsible) may be utilized and provide many of the benefits discussed herein.

Preferably, for collapsible embodiments of the tool apparatus, the length of the tool can be selectively extended, collapsed, or rotated by any suitable means. Examples include, without limitation, using a mechanical switch, physical pressure, rotational or linear drive systems, electrical motors and/or pneumatic actuators, and/or any combination of those or other structures and methods. In preferred embodiments, the tool can be placed in a variety of lengths that each provide sufficient strength for the expected pushing, pulling, and other forces that may be exerted on the tool.

For embodiments that may be readily used on many RVs, the range of lengths (for extending or shortening the tool) preferably provides sufficiently long reach (when extended) and relatively small storage space requirement (when collapsed). An exemplary extended length that is useful for RV-type applications is somewhere in the range of 40 to 60 inches, although persons of ordinary skill in the art will understand that a very broad range of extended and/or collapsed dimensions may be used, depending on the application for which the particular embodiment is expected to be used.

Also depending on the application for which the embodiment is expected to be used, that embodiment of the invention may have one or more of the following features and/or capabilities, or may otherwise:
be used to pull awnings 55 out to an extended position, without breaking the awning or the tool 10;
be used to generally pull or push many different objects into a desired position or location;
be used to unlock and lock latches (such as for awnings or other lockable devices);
have an added protection layer/coating or other non-scratch feature on the pulling/engagement end 5 of the tool. In addition to helping against rust and corrosion on the tool, or regardless whether it provides that benefit to the tool, that coating or other non-scratch surface can help to protect the RV 50 or other apparatus from scratches or other damages;
have ribs or some other no-slip features (or include low or no-slip materials) on the tool's grip 15 or grips;
have any geometric cross-section within the collapsible sections 20 of the tool. Although illustrated as an oval cross-section, it can be triangular, round, or even rectangular or square (or pentagonal);
for collapsible embodiments, have its collapsible cross-section oriented in any direction relative to the two ends of the tool (the engagement end 5 and the grip 15);
have the engagement end 5 and the grip portion 15 located at positions other than at the two ends of the tool;
have the engagement end 5 of the tool oriented in a wide range of useful relationships to the tool's main handle, including having that orientation be adjustable (by pivoting about a screw that is tightened, for example);
have the engagement end 5 of the tool in any of a wide range of shapes and sizes, including by way of example having multiple fingers (rather than the single “finger” 25 shown in the drawings);
include an accessory pack that may or may not be affixed to the tool itself. By way of example but not by way of limitation, the accessory pack can serve as a storage bag/container for the tool, and/or can include items stored inside it, such as one or more of the following: a mirror, an adaptor or other tool to better push blocks under wheels and jack stands, a clamp for grasping items, one or more differently angled hooks for opening storage compartments or performing other tasks;
provide light (similar to a flashlight function) to make it easier to use the tool in low-light conditions (for example, so that a person using the tool can more easily see the “target” at which he/she is aiming the tool, to engage it or lock/unlock something, or retrieve or pull/push items, etc.). Preferably, the light 30 is an LED or similar long-lived and relatively rugged light source, and is positioned at a selected distance away from and is aimed toward the engagement end 5 of the device, to enable the light to shine on the likely area of engaging, pulling, pushing, etc.;
provide that same light apparatus 30 in a form that ALSO can be used in situations where a regular flashlight could be used, regardless whether the rest of the tool itself is being used at the time;
have an actuation mechanism or switch 35 for the light 30 located on or near the tool's hand grip area 15, and/or on or near the tool's light generation area;
have for the light or lights any suitable power supply (including an appropriate number or size of batteries—preferably sufficiently small to mount on board the tool itself), a solar charging cell/battery, a mechanical winding/charging apparatus (dynamo), the ability to plug into an extension cord or power outlet for obtaining electricity in that manner, etc.);
for on-board battery embodiments, have one or more easy access openings to the battery compartment;
have any of a wide range of reflector or lens configurations, as well as any type of coating or optics medium on one or more of the parts related to the lighting system; and
have any and/or all other safety and/or utilitarian elements and features to ensure that it is safe around, and useful in connection with, outdoor situations involving RVs, travel trailers, motorhomes, boats, trailers, tractor trailers, etc.

As indicated above, the particular materials, dimensions, and fabrication methods for practicing the invention can be selected from a wide range of possibilities, depending on a number of factors. By way of example, the absolute and relative sizes of the various components can vary widely, depending on the application to which the invention is directed. Moreover, the various elements of the invention can be formed by any suitable method(s) and from any suitable material(s).

As shown in the figures, in a preferred embodiment of the present invention, a light apparatus is provided. Preferably, the light apparatus may be provided as an integral part of the tool, such as affixed along the body of the tool, however persons of ordinary skill in the art will appreciate that the light apparatus may be provided as a separate component of the tool that may be temporarily or permanently attached to the tool in any suitable manner. In a preferred embodiment, the light is positioned on the tool so that when in use, the light is directed at and illuminates the “target” at which the tool is aiming. This is especially beneficial in low-light and/or dark (i.e., night) conditions. Persons of ordinary skill will understand that any suitable actuation mechanism, such as a button(s), may be provided on the light apparatus, the tool, or even as a separate element for turning the light “on” and “off”.

Preferably, the invention is practiced in a modular manner, so that the various components (e.g., the engagement element 25, the handle 15, the extension sections 20; and any other apparatus used in practicing the invention) are effectively interchangeable with other such components. These components may even be used in retrofitting or otherwise performing maintenance on existing devices. This enables easy customization, maintenance, and repair of an overall assembly 10. Depending on the application, certain components may be shaped differently than shown in the attached drawings, but their functionality preferably is at least substantially unaffected by such changes.

By way of example, persons of ordinary skill in the art will understand that, although certain of the wire-frame drawings appear to show the engagement end 5 of the tool as being segmented, many embodiments will not include any such segmentation and instead will be formed from a single, continuous piece of metal, plastic, or other material.

Although the elements of the assembly preferably are modular, they can be fabricated in combinations and sub-combinations, and can be relatively permanently assembled or otherwise utilized, all without departing from the spirit and scope of the invention. Also, the width, length, thickness, weight, and other dimensions and specifications of the various parts in any particular embodiment of the tool preferably can vary according to the application.

Further, persons of ordinary skill in the art will understand that although the preferred assembly of the present invention is collapsible, it may also be provided in foldable and/or telescoping embodiments, among some of the many alternatives. As shown in the drawings, these alternative embodiments may provide many benefits including being easily transported and stored when not in use, requiring less packaging and physical space for shipping and/or retail sale, among many others.

In an alternative embodiment of the tool being foldable, one or more “joints” may be provided along the tool such that the tool is comprised of “segments” along its length. Preferably, the tool may be bent at each joint in order to fold each segment upon its adjacent segment until all of the joints are bent and the tool is in its final folded configuration. Persons of ordinary skill in the art will appreciate that any number of “joints” and “segments” may be provided along the tool, and that those joints and segments will determine the final folded configuration and size of the tool.

In those telescoping embodiments of the present invention, one or more sections are provided along the tool with each section being telescopically seated within an adjacent section. Preferably, each section has an inner diameter or width that is sufficiently larger than an outer diameter or width of an adjacent section, so as to allow movement along the longitudinal axis of the telescoping system. Persons of ordinary skill in the art will appreciate that the section(s) may have any suitable cross-sectional shape, including but not limited to circular, oval, square, rectangular, triangular, among others. When a user desires to “collapse” the tool, each section may move (i.e., slide or translate) relative to its adjacent section in response to a force applied at either or both ends of the tool. Further, persons of ordinary skill in the art will appreciate that in some embodiments, one or more sections may be provided with a locking mechanism or some other protruding element in order to “lock” the sections in place at a desired length of the tool.

For the purpose of summarizing the invention, certain objects and advantages have been described herein. It is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

The apparatus and methods of the invention have been described with some particularity, but the specific designs, constructions, and steps disclosed are not to be taken as delimiting of the invention. A wide range of modifications and alternative structures and steps for practicing the invention will make themselves apparent to those of ordinary skill in the art, all of which will not depart from the essence of the invention, and all such changes and modifications are intended to be encompassed within the appended claims.

1. Apparatus for manipulating a thing remote from a user, including a handle positioned to permit the user to hold and operate the apparatus, an engagement element remote from the handle, said engagement element sized and configured to selectively engage the thing in either a pushing relationship or a pulling relationship with respect to the user, and a connection structure between the handle and the engagement element, the connection structure likewise being sized and configured and fabricated for selective pushing or pulling of the thing by the user.

2. The apparatus of claim 1, further including a recreational vehicle on which at least one said thing is located.

3. A method of moving an awning between an open and a closed position and/or vice versa, including providing the apparatus of claim 1, engaging it with the awning, and using the apparatus to move the awning.
